(19) United States
(12) Patent Application Publication
(10) Pub. No.: US 2004/0166966 A1
(43) Pub. Date: Aug. 26, 2004

(54) Portable scoreboard

(75) Inventor: Niel E. Nielsen, LaGrange, IL (US)

Correspondence Address: BANNER & WITCOFF, LTD., TEN SOUTH WACKER DRIVE, SUITE 3000, CHICAGO, IL, 60606, US

(73) Assignee: Niel Nielson, LaGrange, IL (US)

(21) Appl. No.: 10/122,557

(22) Filed: Apr. 15, 2002

Related U.S. Application Data
(63) Continuation of application No. 09/389,391, filed on Sep. 3, 1999, now abandoned.
(60) Provisional application No. 60/099,219, filed on Sep. 4, 1998.

(51) Int. Cl. A63B 69/00; G06F 17/00; G06F 19/00

(52) U.S. Cl. 473/451; 463/43

(57) ABSTRACT

The preferred scoreboard of this invention includes an electronic controller, an antenna, a power source, and commercially available electromechanical display devices, inside a weatherproof case, and two alternative remote control units, one a full function remote control, and the other a partial function, or “umpire,” remote control. The electronic controller includes a microprocessor, an RF receiver section, a power control section, and a display control section. It may also include, and preferably does include, an address selection section and a battery voltage measurement section. The RF receiver section receives pulsed or coded radio frequency signals from the remote controls, and converts them to binary DC signals for the microprocessor. The microprocessor decodes the input and controls the display control section. The display control section controls the switching of power to individual electromagnets in the electromechanical display devices. The power control section provides a controllable regulated voltage to the microprocessor, and a separately controlled regulated voltage to the display control section. The available address selection allows “unit address” selection and rejects incoming signals from remote controls that lack the identical unit address. The available battery voltage measurement section allows the condition of the power source to be displayed.

This patent application is a non-provisional of the earlier filed copending provisional patent application, Serial No. 60/099,219 entitled “Portable Scoreboard,” filed on Sep. 4, 1998, for which priority is claimed. This provisional application is incorporated herewith by reference in its entirety.

### BACKGROUND OF THE INVENTION

This invention relates to scoreboards, and more particularly, to scoreboards for a variety of sports, that display sporting event information, where the information is changeable during the course of the sporting events.

Scoreboards have perhaps been known as long as sports. In the recent past, scoreboards have ranged from those where scores are still nostalgically changed by hand, as is the centerfield scoreboard at Wrigley Field, for Chicago Cubs baseball games, to highly sophisticated, computer controlled electric scoreboards such as the central scoreboard hanging in the United Center, for Chicago Bulls basketball games. For situations where less funding is available, as in Little League baseball games, and high school football games, scoreboards range from chalkboards written by hand, to hard-wired, simple electrical scoreboards that provide information in a few panels of variably illuminated light bulbs.

### SUMMARY OF THE INVENTION

The overall objective of this device is to provide a low cost, portable, and easy to use system for displaying the score and pertinent game information during a sports game. The first model developed is for use at small baseball fields, although the technology is suitable for other sports such as football, basketball, soccer, and also tennis.

The preferred scoreboard of this invention includes an electronic controller, an antenna, a power source, and commercially available electromechanical display devices, inside a weatherproof case, and two alternative remote control units, one a full function remote control, and the other a partial function, or “umpire,” remote control. The electronic controller includes a microprocessor, an RF receiver section, a power control section, and a display control section. It may also include, and preferably does include, an address selection section and a battery voltage measurement section. The RF receiver section receives pulsed or coded radio frequency signals from the remote controls, and converts them to binary DC signals for the microprocessor. The microprocessor decodes the input and controls the display control section. The display control section controls the switching of power to individual electromagnets in the electromechanical display devices. The power control section provides a controllable regulated voltage to the microprocessor, and a separately controlled regulated voltage to the display control section. The available address selection section allows “unit address” selection and rejects incoming signals from remote controls that lack the identical unit address. The available battery voltage measurement section allows the condition of the power source to be displayed.

### BRIEF DESCRIPTION OF THE DRAWING

FIG. 1 is a view of the display provided by the preferred baseball model of the invention.

FIG. 2 is a view of a first, full function remote control.

FIG. 3 is a view of a second, partial function or “umpire” remote control.

FIG. 4 is a cross-section view of a portion of a case of the preferred embodiment, showing its gasket seal.

FIG. 5 is a schematic of the main board of the electronic controller.

FIG. 6 is a schematic of the full function remote control.

FIG. 7 is a schematic of the partial function remote control.

A listing of reference numbers from the following section is as follows:

10 display unit

12, 14 remote controls

16 case

18 front cover

20 display devices

22 controller 24 antenna

26 power source

30 ledge

32 gasket

34 fastener

### DETAILED DESCRIPTION OF THE PREFERRED EMBODIMENT

### Physical Description

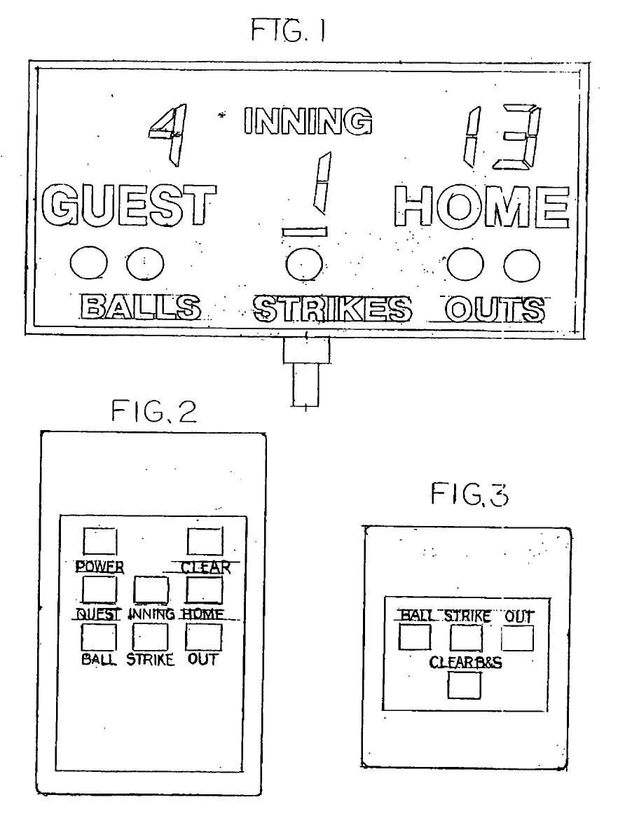

The preferred, first baseball model of the invention displays the home team score, guest team score, inning, balls, strikes and outs, as shown in FIG. 1. The system consists of a display unit 10 and one or more remote controls 12, 14, shown in FIGS. 2 and 3.

### Display Unit

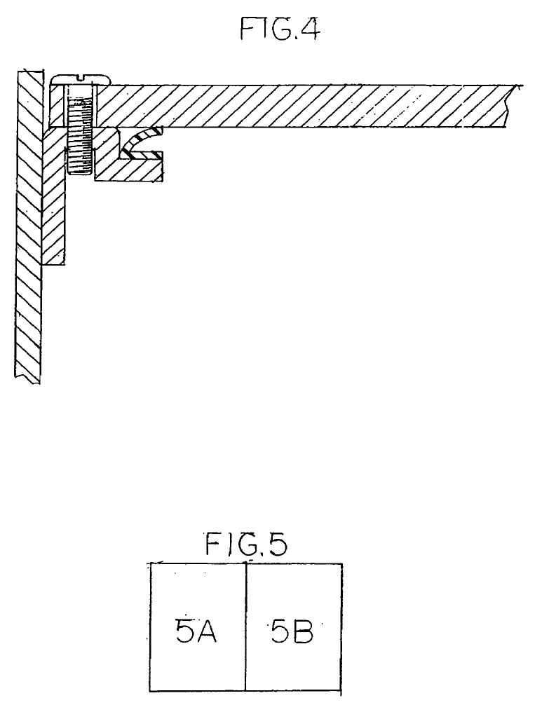

Referring to FIGS. 1 and 4, the display unit 10 includes a case 16, front cover 18, and display devices such as example 20. It also includes a controller, antenna, and power source.

### Case

The case 16 is a five sided box measuring approximately thirty inches wide, sixteen inches tall, and three inches deep. The case 16 is fabricated from a vacuum molded plastic sheet and is designed to be sealed to prevent the ingress of dust and water. The inside of the case provides a mounting surface for the display devices 20, the controller, antenna, and front cover 18.

The case 16 has a ledge 30 just inside the open side of the case 16 which allows mounting the front cover 18. This ledge 30 has a recess for a gasket 32. The gasket 32 provides dust and water resistance while allowing removal of the front panel or cover 18 by the user, by removal of fasteners such as 34. The design of this ledge 30 and recessed gasket 32 provides a stop to locate the front panel 18 in the proper position an simultaneously provides the proper amount of compression of the gasket 32.

The case 16 has fabricated display spacers mounted inside the case. These spacers are for the purpose of holding the numeric display devices 20 as close as possible to the front panel 18 to maximize the viewing angle of the numeric displays. The spacers have fasteners for mounting the displays 20 that allow installing the displays 20 quickly and without tools to minimize final assembly time. The display spacers also provide a mounting means for holding battery holders.

The case 16 has fasteners for holding the controller assembly ball, strike, and out subassemblies formed of devices 20. The fasteners allow the sub assemblies to be installed quickly and without tools to minimize final assembly time.

The case 16 has a hollow protrusion on the back (not shown) that contains a plastic pipe (not shown). There is an opening in the bottom of the case below the plastic pipe that allows a metal pipe to slide up concentrically inside this plastic pipe. There is a locating pin (not shown) near the top inside the plastic pipe and a corresponding notch (not shown) in the top of the metal pipe. When in use, the locating pin drops into the notch to keep the display united oriented in the proper direction. It is intended that the metal pipe will be short, and the user of the device will attach the metal pipe to a longer piece of pipe which is obtained locally, to semi-permanently or permanently mount the pipe assembly at the field of play. The notch in the top of the short pipe is faced toward the spectators. To set up the unit at the event, the user simply slides the display unit down onto the steel pipe and rotates the unit until the locating pin drops down into the notch. At this point gravity holds the unit in place and the locating pin keeps the unit oriented toward the spectators.

### Front Cover

The front panel 18 covers and protects the inner workings and provides labels for the displays. It is made from a durable clear plastic sheet and is attached to the ledge 30 in the case with removable fasteners 34. The cover 18 is removable by the user to provide access to the batteries and for maintenance.

The front panel 18 is reverse printed on the back side, for durability of the printing, with the labels for each display, such as “GUEST,” “INNINGS,” “HOME,” “BALLS,” “STRIKES” and “OUTS,” or other labels for other sports. For those specified, see FIG. 1.

The front panel is coated on the back side, for durability of the coating, with an opaque substance, in the areas that are not in front of the displays. Black ink is most preferred for the opaque substance. This provides a mask to hide the inner workings and wiring while allowing view of the display portions of the displays devices.

### Display Devices

The display devices 20 are attached inside the case 18 facing forward, toward the view. There are display devices 20 for displaying the guest team score, home team score, inning, number of balls, number of outs, and number of strikes. The number may be varied for the information being displayed. The devices 20 for displaying the home score, inning, and guest score are seven segment numeric displays, with two digits each for the home score and guest score, and one digit for the inning. The balls, strikes and outs are displayed by a number of binary “dots,” which are round cards that show as a bright color or black. There are three dots for balls, and two dots each for strikes and outs.

The display devices 20 are commercially available electromechanical displays. When they are numeric displays, with seven segments, they flip various segments forward for viewing on actuation of their magnets. When they are dot displays, they flip the dots forward for viewing. This type of display provides high contrast and very low power consumption.

### Controller

The controller's purpose is to receive the incoming radio frequency signal, decode this signal to determine what button the user is pressing on the remote control, and then change the patterns on the displays in a manner appropriate for the button being pressed.

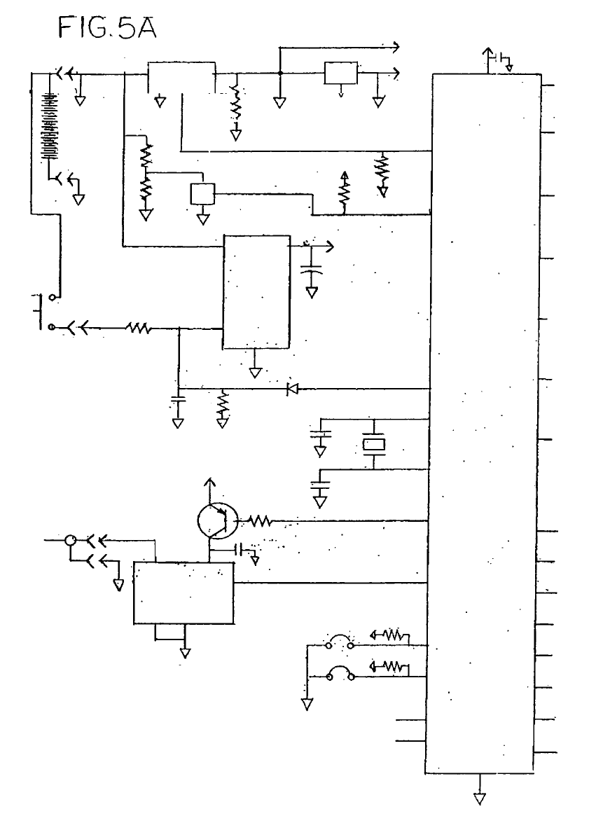

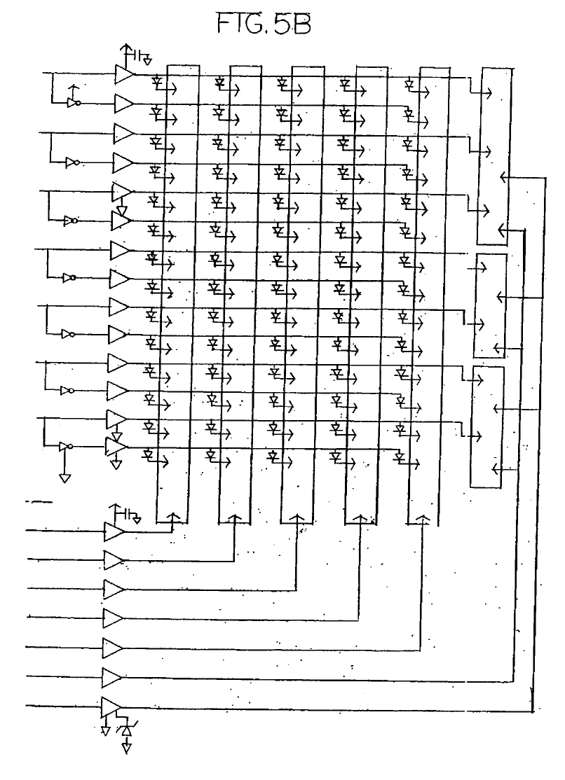

As in FIG. 5, the circuitry of the controller consists of a power control section, an RF receiver section, a microprocessor, an address selection section, a battery voltage measuring section, and a display control section.

### Power Control Section

The power control section provides a controllable regulated voltage to the microprocessor and RF receiver, and separately controlled regulated voltage to the display control section.

The portion that provides regulated voltage to the microprocessor and RF receiver is controlled “on” or “off” by the combination of a user actuated pushbutton and the microprocessor. The user actuated pushbutton turns the voltage “on” and the microprocessor turns the voltage “off”. The voltage regulating portion utilizes a commercially available low power voltage regulator.

The portion that provides regulated voltage to the display control section is controlled “on” and “off” by the microprocessor. To minimize power consumption when the displays are not being changed, the microprocessor turns the regulated voltage to the displays control section “off”. The regulators used in this section are commercially made voltage regulators.

### RF Receiver Station

The purpose of the RF receiver section is to convert the pulsed/coded RF signal into a binary DC signal that can be sensed by the Microprocessor.

A commercially available module is used for this purpose. A transistor is also provided to control the power to this module to allow it to be turned on and off under control of the microprocessor to reduce power consumption when it is not needed.

### Microprocessor

The microprocessor decodes the incoming signal from the RF receiver and controls the display control section to provide the proper patterns on the displays. A commercially available microprocessor is used that has sufficient number of inputs and outputs and also has a low power consumption. The microprocessor is programmed with code that performs the functions of: performing a power on self test that cycles all of the electromechanical displays on then off, decoding the incoming signal from the RF receiver to determine which button is being pressed on the remote control, rejecting signals from remotes with the wrong unit addresses, determining the correct pattern to place on the displays, operating the display control circuits to pulse proper electromagnets to achieve the desired patterns, notifying the user that the battery power is low, and turning off the unit via the power control section when the user signals “power off” or if a certain time period has passed without reception of an RF signal (the power off sequence briefly displays “PO” on both score displays to indicate that the unit is powering off).

### Address Selection Section

The controller board has two user setable jumpers for selecting the “unit address” of the unit. This is necessary when the system is being used when other similar units are being used nearby. The microprocessor reads the status of the two jumpers and will reject incoming signals from remote controls that do not have the identical unit addresses.

### Battery Voltage Measurement Section

The controller board contains circuitry to determine the condition of the batteries in the display unit. The circuit consists of a voltage divider that feeds a commercially available low power voltage detector. The output of the voltage detector is fed to the microprocessor.

### Display Control Section

The display control section controls the switching of power to the individual electromagnets in the displays.

The display control section uses a “multiplexed” scheme, controlling a total of 84 electromagnets using only 14 outputs from the microprocessor. The system is organized as 7 outputs and 7 strobe lines. The multiplexed output system reduces the number of and cost of the circuits to drive to the displays. The system also has a current steering diode for each electromagnet to prevent “sneak” paths of current through electromagnets tat are not being intentionally driven, and a zener diode for limiting the voltage of the inductive kickback “spike” that occurs when turning off the current to the electromagnetic coils.

### Antenna

The antenna receives the RF electromagnetic energy from the air and converts the energy into an RF electrical signal that is fed to the controller board.

The antenna used here is a full wave dipole antenna of proper length for the frequency being used. It is made from a piece of coax cable with the outer braid stripped off and the shield braid is separated from the center conductor and then formed into a “T”, forming the half wave dipole. This design is very low cost.

The antenna is fastened into the inside of the case to protect it from damage from the user.

### Power Source

The power source chosen for this unit is commercially available alkaline batteries. These provide a high power to weight ratio. The batteries are held in commercially available battery holders which are held in place inside the unite using elastomeric bands fastened to the display spacers.

### Remote Controls

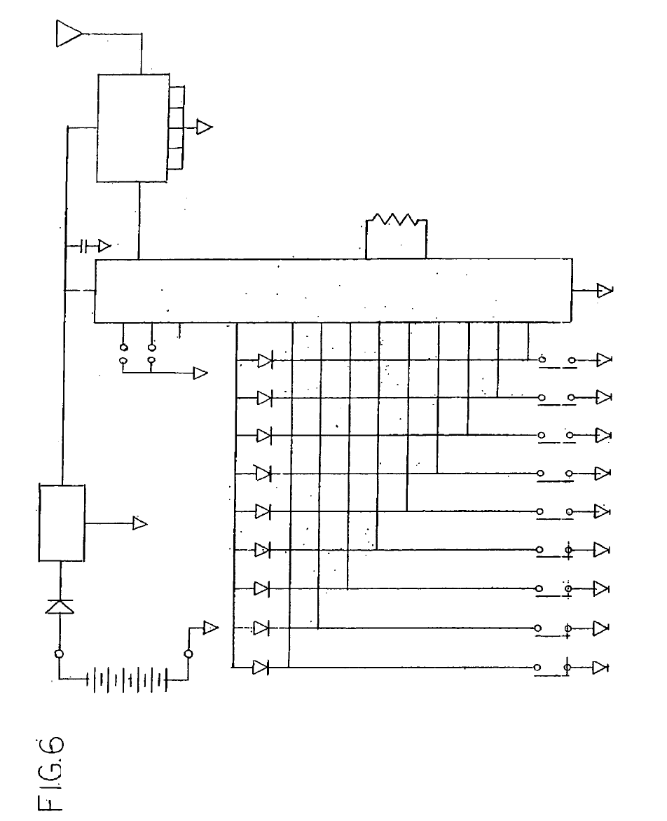

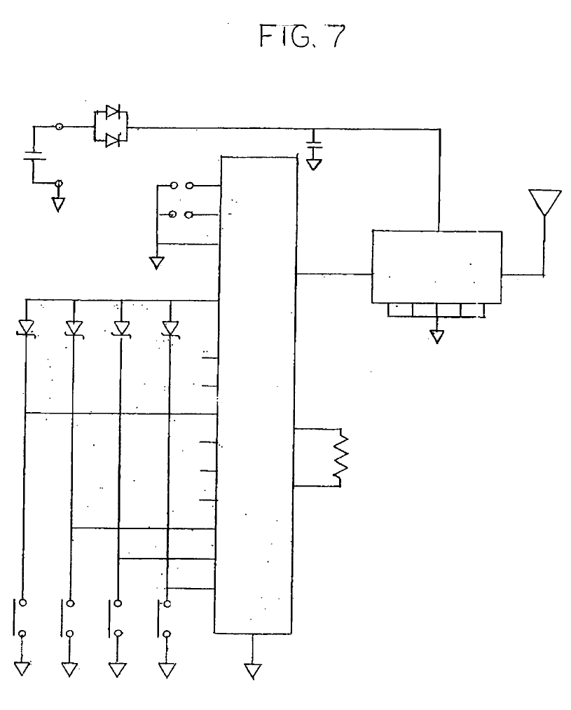

The remote controls are shown externally in FIGS. 2 and 3. Their schematics are FIGS. 6 and 7. The purpose of the remote controls is to allow the user to signal the display device to change the patterns on the displays. Two remote controls can be used, either a full function remote control or an “umpire” remote control.

### Full Function Remote

The full function remote is a hand held device measuring approximately four (4) inches tall by two and one half (2½) inches wide by one (1) inch thick. The case is made of plastic to allow the antenna to be mounted on the inside and pass the radio signals through the case. The unit has eight push buttons, for the following functions: power off, clear item, increment guest score, increment innings, increment home score, increment balls, increment strikes, and increment outs. The pushbuttons are arranged in the same order as the displays on the display unit for ease of use. The unit is battery powered, and has a low enough power consumption for the battery to last many years. The circuitry inside the case consists of a commercially available encoder ship that scans the pushbuttons for a key press and if a key is pressed, outputs a serially encoded signal that indicates which button(s) are pressed. In addition, the unit has user configurable jumpers that allow a two bit unit address to be transmitted in the bit stream to allow distinguishing this unit from others that me by operating in close proximity. A third bit of the address is left high to distinguish the full function remoter from the umpire remote. The output of the encoder chip is fed to a commercially available RF transmitter module that modulates an RF signal in direct unison to the incoming signal from the encoder chip. The output from the RF module is fed to an antenna, which can be a helical antenna mounted to the circuit board, or a loop antenna that is part of the copper traces on the circuit board, or a short external antenna that is mounted on the end of the case.

### Umpire Remote

The umpire remote is a device similar to the full function remote, but is smaller and controls only those functions that an umpire is directly responsible for. The case of the umpire remote measures approximately two and three quarter (2¾) inches tall by two and one quarter (2¼) inches wide by three quarter (¾) inches thick. It has four pushbuttons for the following functions: increment balls, increment strikes, increment outs, and clear balls & strikes. The unit is battery powered and the low power consumption of the circuitry allows the battery to last for many years. The circuitry is identical to the full function remote except there are only four pushbuttons instead of eight, and one of the addressing bits to the encoder chip is pulled low to encode in the bit stream that this is an umpire remote.

The invention, and especially the preferred embodiment, are now described in such full, clear, concise and exact terms as to enable the person of ordinary skill in the art to make and use the invention. All departures from the preferred embodiment that fall within the limits of the claims are claimed as part of the invention.

What I claim is:

1. A scoreboard comprising an electronic controller, and electromechanical display devices, and functional with at least one remote control unit, an antenna, and a power source, and also suitable to be placed in a case; the electronic controller including a microprocessor, an RF receiver section, a power control section, and a display control section, all operatively, electrically connected, with the RF receiver section also operatively, electrically connected to the antenna; wherein the RF receiver section receives pulsed or coded radio frequency signals from the antenna and thereby from remote control, and converts them to binary DC signals for the microprocessor; wherein the microprocessor decodes the input and responsively controls the display control section; wherein the display control section controls the switching of power to individual electromagnets in the electromechanical display devices, for displays in appropriate response to remote control; and wherein the power control section provides a controllable regulated voltage to the microprocessor, and a separately controlled regulated voltage to the display control section, from the power source.

2. A scoreboard as in claim 1, the electronic controller further comprising an address selection section that allows “unit address” selection and rejects incoming signals from remote controls that lack the identical unit address.

3. A scoreboard as in claim 1, the electronic controller further comprising a battery voltage measurement section that allows the condition of the power source to be displayed.

4. A scoreboard as in claim 1, in which the case, antenna and power source are a part of the scoreboard, with the electronic controller, display devices, and power source are in the case.
